(19) United States
(12) Patent Application Publication
(10) Pub. No.: US 2022/0024155 A1
(43) Pub. Date: Jan. 27, 2022

(54) PREPREG MOLDING METHOD

(71) Applicant: MITSUBISHI HEAVY INDUSTRIES, LTD., Tokyo (JP)

(72) Inventors: Toshiki KITAZAWA, Tokyo (JP); Masahiko SHIMIZU, Tokyo (JP); Shoya MANO, Tokyo (JP); Hiromichi AKIYAMA, Tokyo (JP); Kenji MURAKAMI, Tokyo (JP)

(21) Appl. No.: 17/312,027

(22) PCT Filed: Jan. 28, 2020
(86) PCT No.: PCT/JP2020/002952

§ 371 Date: Jun. 9, 2021

(30) Foreign Application Priority Data
Mar. 26, 2019 (JP) 2019-058970

(51) Int. Cl. B29C 70/34; C08J 5/24; B29C 70/54; B29C 70/50

(52) U.S. Cl. CPC B29C 70/34; C08J 5/24; B29C 70/504; B29C 70/545; B29C 70/543

(57) ABSTRACT

The purpose of the present invention is to suppress generation of creases when one layer of a prepreg is molded at a time and molded layers of the prepreg are laminated one by one. A prepreg molding method comprises: a step of bending a long prepreg elongated in one direction into a downwardly convex U-shape in cross section; a step of bringing a lower part of the prepreg bent in the U-shape into contact with a bottom part of a mold having a concave cross section and mounting the prepreg on an inner part of the mold; and a step of pressing and deforming the prepreg mounted on the inner part of the mold using pressing part.

### TECHNICAL FIELD

The present disclosure relates to a prepreg molding method.

### BACKGROUND ART

Structural members (for example, a stringer and the like) of an aircraft may be made of a fiber reinforced plastic (FRP) (hereinafter, referred to as a “composite material”). The stringer is a long component that is long in one direction, and the cross-sectional shape of the stringer may change along a longitudinal direction, and a twist or a contour may be formed according to the location of application in the aircraft. The cross-sectional shape of the stringer is a hat shape, a Z shape, or the like. The stringer of a hat type includes flange portions formed at both ends, a hat portion formed at the center, and a web portion connecting the flange portions and the hat portion.

When the stringer is produced from a composite material, an automatic lamination device cannot form, for example, an arc-shaped (rounded) portion having a large curvature in a recessed portion by direct lamination. For this reason, a desired structural member is produced from the composite material by flatly laminating a plurality of prepregs to form a laminate (charge), and deforming (molding) the laminate into a target shape.

PTLS 1 to 3 below disclose a method in which a flat laminate is pushed into a molding tool by using a roller, to deform (bend) the laminate, thus to form a molded article having a hat shape.

### CITATION LIST

### Patent Literature

[PTL 1] Japanese Examined Patent Application Publication No. 5937894

[PTL 2] US Unexamined Patent Application Publication No. 2016/0082675 Specification

[PTL 3] PCT Japanese Translation Utility Model Registration Publication No. 2007-501140

### SUMMARY OF INVENTION

### Technical Problem

As disclosed in PTLS 1 and 2, when a flat or gently curved laminate in which a plurality of prepregs are laminated is molded to have a hat-shaped cross section, it is necessary to bend the laminate. In this case, it is necessary to properly generate slippage between the prepregs adjacent to each other. When the prepreg does not slide properly between the prepregs (between layers) due to frictional force, the prepreg may be left in an intermediate portion, and wrinkles or the like may be generated due to the surplus prepreg generated in the intermediate portion.

As disclosed in PTL 3, when the prepregs are molded one layer at a time to have a hat-shaped cross section, and the prepregs are sequentially laminated, it is necessary to laminate the prepregs while causing the prepreg which has already been molded and the prepreg to be newly molded to slide against each other. Also in this case, when the prepreg does not slide properly due to frictional force, wrinkles or the like may be generated.

The present disclosure has been made in view of such circumstances, and an object of the present disclosure is to provide a prepreg molding method capable of suppressing wrinkles from being generated when molding prepregs one layer at a time and sequentially laminating the prepregs.

### Solution to Problem

In order to solve the above problem, a prepreg molding method of the present disclosure employs the following means.

Namely, according to an aspect of the present disclosure, there is provided a prepreg molding method including: a step of bending a first prepreg to have a downward projecting U shape in a cross-sectional shape, the first prepreg having an elongated shape long in one direction; a step of placing the first prepreg inside a molding tool such that a lower portion of the first prepreg bent into a U shape comes into contact with a bottom portion of the molding tool having a recessed cross section or an upper surface of a second prepreg molded and placed along the molding tool; and a step of pressing and deforming the first prepreg, which is placed inside the molding tool, by using the pressing unit.

According to this configuration, the first prepreg is bent to have a downward projecting U shape in a cross-sectional shape, and the first prepreg is placed inside the molding tool such that the lower portion of the first prepreg bent into a U shape comes into contact with the bottom portion of the molding tool having a recessed cross section. Then, the pressing unit presses and deforms the first prepreg placed inside the molding tool.

Since the first prepregs are molded one by one, when the first prepregs are deformed by the pressing unit, a plurality of prepregs are not required to slide simultaneously. For this reason, the generation of wrinkles due to the prepreg not sliding properly between the plurality of prepregs is suppressed. Particularly, the generation of wrinkles by the influence of an arc-shaped (rounded) portion having a large curvature in a recessed portion or a portion which is three-dimensionally shaped (contoured) in a longitudinal direction is suppressed.

The cross-sectional shape of the first prepreg is deformed into a U shape, and thereafter, the first prepreg is placed inside the molding tool such that the lower portion of the first prepreg comes into contact with the bottom portion of the molding tool. Then, the pressing unit presses and deforms the first prepreg placed inside the molding tool.

Before molding is performed by using the pressing unit, the first prepreg is placed in a state where the lower portion of the first prepreg deformed into a U shape is brought into contact with the bottom portion of the molding tool having a recessed cross section. Accordingly, when molding is performed by using the pressing unit, the first prepreg to be newly molded is deformed without generating slippage with respect to the molding tool, so that the generation of wrinkles is suppressed.

When the second prepreg deformed along the molding tool is placed inside the molding tool, the cross-sectional shape of the first prepreg is deformed into a U shape, and thereafter, the first prepreg is placed inside the molding tool such that the first prepreg comes into contact with the upper surface of the second prepreg molded on the molding tool. Then, the pressing unit presses and deforms the first prepreg placed inside the molding tool.

Before molding is performed by using the pressing unit, the first prepreg is placed in a state where the lower portion of the first prepreg deformed into a U shape is brought into contact with the upper surface of the second prepreg molded and placed along the molding tool. Accordingly, when molding is performed by using the pressing unit, the first prepreg to be newly molded is deformed without generating slippage with respect to the second prepreg, so that the generation of wrinkles is suppressed.

In the above aspect, the first prepreg may be supplied toward the molding tool to be placed on the molding tool such that a direction of fibers has a predetermined angle with respect to a longitudinal direction.

According to this configuration, the first prepreg is supplied toward the molding tool such that the direction of the fibers has the predetermined angle with respect to the longitudinal direction. Therefore, the efficiency of lamination is improved. Since the direction of the fibers of the first prepreg to be placed on the molding tool has the predetermined angle with respect to the longitudinal direction, a laminate to be formed is formed to satisfy a target strength.

In the above aspect, the first prepreg may be progressively deformed from one end side toward the other end side in a longitudinal direction such that the cross-sectional shape of the first prepreg becomes a U shape. The first prepreg deformed into a U shape may be progressively placed inside the molding tool from one end side toward the other end side of the molding tool.

According to this configuration, the first prepreg is progressively deformed from the one end side toward the other end side in the longitudinal direction such that the cross-sectional shape of the first prepreg becomes a U shape, and the first prepreg deformed into a U shape is progressively placed inside the molding tool from the one end side toward the other end side of the molding tool.

In the above aspect, the first prepreg may be supplied toward the molding tool, and a direction of the first prepreg may be changed at a placement position at which the first prepreg is to be placed inside the molding tool. At the placement position, the cross-sectional shape of the first prepreg may be changed from an upward projecting U shape to a downward projecting U shape, or upper portions on both sides of a downward projecting U shape may be bent inward and disposed.

According to this configuration, when the first prepreg is supplied toward the molding tool, the direction of the first prepreg is changed at the placement position at which the first prepreg is to be placed inside the molding tool. In this case, at the placement position, the cross-sectional shape of the first prepreg is changed from an upward projecting U shape to a downward projecting U shape, or upper portions on both sides of a downward projecting U shape are bent inward and disposed such that a bent portion (kink) is not generated in the first prepreg. Accordingly, the cross-sectional shape of the first prepreg is stably changed to a downward projecting U shape at the placement position.

In the above aspect, the first prepreg may be simultaneously deformed from one end side to the other end side in a longitudinal direction such that the cross-sectional shape of the first prepreg becomes a U shape. The first prepreg deformed into a U shape may be simultaneously placed inside the molding tool from one end side to the other end side of the molding tool.

According to this configuration, the first prepreg is simultaneously deformed from the one end side to the other end side in the longitudinal direction such that the cross-sectional shape of the first prepreg becomes a U shape, and the first prepreg deformed into a U shape is simultaneously placed inside the molding tool from the one end side to the other end side of the molding tool.

In the above aspect, the first prepreg may be placed inside the molding tool, together with a delamination sheet, and the delamination sheet and the first prepreg may be pressed and deformed by using the pressing unit.

According to this configuration, the first prepreg is placed inside the molding tool, together with the delamination sheet, and the delamination sheet and the first prepreg are pressed and deformed by using the pressing unit. Accordingly, friction generated between the first prepreg and the pressing unit is further reduced than when the delamination sheet is not provided.

In the above aspect, when the first prepreg is placed inside the molding tool, a slit may be formed in the first prepreg.

According to this configuration, when the first prepreg is placed inside the molding tool, a slit is formed in the first prepreg, so that the first prepreg is easily deformed by the molding tool and the pressing unit. The slit to be formed is aligned, for example, in a direction perpendicular to the longitudinal direction (90° direction).

In the above aspect, before the first prepreg is placed on the molding tool, the molding tool or the second prepreg may be heated.

According to this configuration, before the first prepreg is placed in the molding tool, the molding tool or the second prepreg is heated, so that the first prepreg is easily deformed by the molding tool and the pressing unit. In addition, since the adhesiveness of the first prepreg is improved due to a rise in temperature, the bonding between the prepregs is enhanced.

In the above aspect, before the first prepreg is deformed by using the pressing unit, the first prepreg may be heated.

According to this configuration, before the first prepreg is deformed by using the pressing unit, the first prepreg is heated, so that the first prepreg is easily deformed by the molding tool and the pressing unit. In addition, since the adhesiveness of the first prepreg is improved due to a rise in temperature, the bonding between the prepregs is enhanced.

In the above aspect, the pressing unit may be heated or caused to generate heat, and the first prepreg may be deformed by using the pressing unit.

According to this configuration, when the first prepreg is deformed by using the pressing unit, the pressing unit is heated or the pressing unit generates heat, so that the first prepreg is easily deformed by the molding tool and the pressing unit. In addition, since the adhesiveness of the first prepreg is improved due to a rise in temperature, the bonding between the prepregs is enhanced.

In the above aspect, the pressing unit may have a projecting cross section having a shape corresponding to a cross-sectional shape of the molding tool.

According to this configuration, the first prepreg placed inside the molding tool is pressed and deformed by the pressing unit having a projecting cross section having the shape corresponding to the cross-sectional shape of the molding tool.

In the above aspect, the pressing unit may be configured such that a cross-sectional shape of the pressing unit is changeable according to a target shape of a laminate.

According to this configuration, the cross-sectional shape of the pressing unit is changeable according to the target shape of the laminate. Therefore, it is possible to deform the first prepreg to correspond to various shapes without requiring to prepare a plurality of types of the molding tools.

In the above aspect, the pressing unit may be an injection nozzle that injects a fluid, and deform the first prepreg along the molding tool by using a pressure of the injected fluid.

According to this configuration, the pressing unit is the injection nozzle that injects a fluid, and deforms the first prepreg along the molding tool by using the pressure of the injected fluid. When the first prepreg is deformed along the molding tool, the first prepreg does not come into contact with the pressing unit, so that wrinkles or the like are less likely to be generated in the prepreg.

According to another aspect of the present disclosure, there is provided a prepreg molding method including: a step of placing a first prepreg on a molding tool having a recessed cross section or a projecting cross section; and a step of pressing and deforming the first prepreg, which is placed on the molding tool, by using a pressing unit. The pressing unit is an injection nozzle that injects a fluid, and deforms the first prepreg along the molding tool by using a pressure of the injected fluid.

According to this configuration, the first prepreg is placed on the molding tool having a recessed cross section or a projecting cross section, and the first prepreg placed on the molding tool is pressed and deformed by the pressing unit. In this case, the pressing unit is an injection nozzle that injects a fluid, and deforms the first prepreg along the molding tool by using the pressure of the injected fluid. When the pressing unit which comes into direct contact with the prepreg is used, the pressing unit comes into direct contact with the first prepreg to press and deform the first prepreg, so that friction between the pressing unit and the first prepreg is generated. When the prepreg does not slide properly due to frictional force, wrinkles or the like may be generated in the prepreg. On the other hand, when the first prepreg is deformed along the molding tool by using the pressure of the injected fluid, the first prepreg does not come into contact with the pressing unit, so that wrinkles or the like are less likely to be generated in the prepreg.

### Advantageous Effects of Invention

According to the present disclosure, when the prepregs are molded one layer at a time and the prepregs are sequentially laminated, the generation of wrinkles can be suppressed.

### BRIEF DESCRIPTION OF DRAWINGS

FIG. 1 is a schematic configuration view illustrating a prepreg lamination molding device according to one embodiment of the present disclosure.

FIG. 2A is a plan view illustrating a prepreg.

FIG. 2B is a plan view illustrating a prepreg.

FIG. 3A is a lateral cross-sectional view illustrating a molding tool and a prepreg.

FIG. 3B is a lateral cross-sectional view illustrating the molding tool, a pressing unit, and the prepreg.

FIG. 3C is a lateral cross-sectional view illustrating the molding tool, the pressing unit, and the prepreg.

FIG. 3D is a lateral cross-sectional view illustrating the molding tool, the pressing unit, and the prepreg.

FIG. 4 is a schematic configuration view illustrating the pressing unit of the prepreg lamination molding device.

FIG. 5 is a schematic configuration view illustrating injection nozzles of the pressing unit of the prepreg lamination molding device.

FIG. 6 is a schematic configuration view illustrating the injection nozzles of the pressing unit of the prepreg lamination molding device, and is a view illustrating a lateral cross section of the molding tool.

FIG. 7 is a schematic configuration view illustrating a modification example of the prepreg lamination molding device according to one embodiment of the present disclosure.

FIG. 8 is a longitudinal cross-sectional view illustrating the molding tool and the prepreg.

FIG. 9A is a lateral cross-sectional view illustrating the prepreg.

FIG. 9B is a lateral cross-sectional view illustrating the prepreg.

FIG. 9C is a lateral cross-sectional view illustrating the prepreg.

FIG. 9D is a lateral cross-sectional view illustrating the prepreg.

FIG. 10 is a side view illustrating the prepreg.

FIG. 11A is a lateral cross-sectional view illustrating the prepreg.

FIG. 11B is a lateral cross-sectional view illustrating the prepreg.

FIG. 11C is a lateral cross-sectional view illustrating the prepreg.

FIG. 11D is a lateral cross-sectional view illustrating the prepreg.

FIG. 11E is a lateral cross-sectional view illustrating the prepreg.

FIG. 12 is a side view illustrating rollers and the prepreg.

FIG. 13 is a plan view illustrating the rollers and the prepreg.

FIG. 14 is a longitudinal cross-sectional view illustrating the molding tool and the prepreg.

FIG. 15 is a lateral cross-sectional view illustrating the molding tool and the prepreg.

FIG. 16 is a front view illustrating clamp portions and a push portion.

FIG. 17 is a front view illustrating bending portions.

FIG. 18 is a lateral cross-sectional view illustrating the molding tool and the pressing unit, and illustrates a prepreg molding method in the related art.

### DESCRIPTION OF EMBODIMENTS

Hereinafter, embodiments according to the present disclosure will be described with reference to the drawings.

A molded fiber reinforced plastic article is formed from a fiber reinforced plastic (FRP) formed of a fiber preform and a resin. The molded fiber reinforced plastic article is an FRP structure forming an aircraft, a molded FRP article forming various other devices and structures, or the like. A stringer which is one of the FRP structures is an elongated member that is long in one direction, and the dimension of the stringer in a longitudinal direction is longer than the dimension thereof intersecting the longitudinal direction. The lateral cross section of the stringer is, for example, a hat shape.

The stringer of a hat type includes flange portions formed at both ends, a hat portion formed at the center, and a web portion connecting the flange portions and the hat portion.

A prepreg is a sheet-shaped member in which a fiber preform is infiltrated with a resin. Any fiber such as a carbon fiber or a glass fiber is used as the fiber preform. A required number of prepregs are laminated according to the thickness of the stringer to laminate a plurality of the prepregs, thus to form a laminate.

After the laminate is molded (formed) into a target shape by using a prepreg lamination molding device 1 according to the present embodiment, the molded laminate is heated and/or pressed by using an autoclave or the like to cure the resin, thus to form a molded fiber reinforced plastic article.

Next, the prepreg lamination molding device 1 according to a first embodiment of the present disclosure will be described.

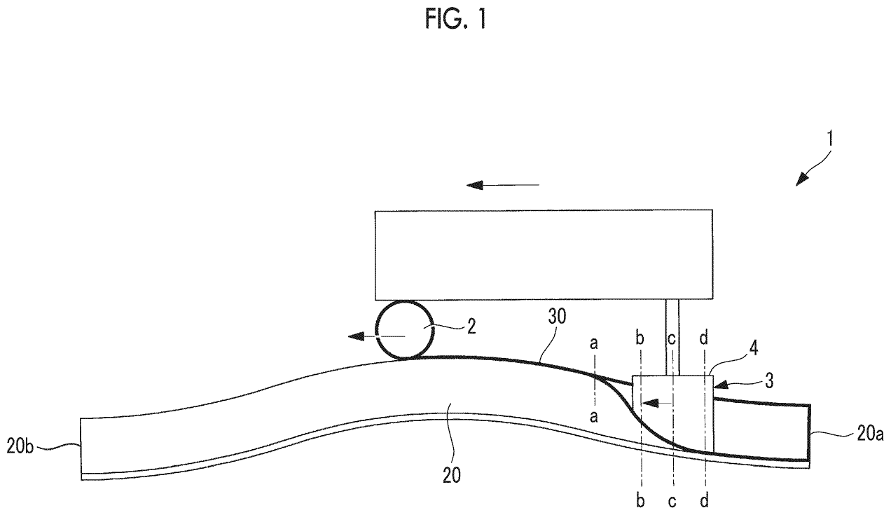

As illustrated in FIG. 1, the prepreg lamination molding device 1 according to the present embodiment includes a prepreg supply unit 2, a pressing unit (compaction tool) 3, and the like. The prepreg lamination molding device 1 supplies a prepreg 30 toward a molding tool (mandrel) 20 one ply at a time to place the prepreg 30 inside the molding tool 20, and then presses the prepreg 30, which is placed, by using the pressing unit 3 to deform the prepreg 30. Next, another prepreg 30 is supplied and placed on an upper surface of the prepreg 30 which has been deformed, and is deformed by using the pressing unit 3. This operation is repeated one ply at a time to laminate a plurality of the prepregs 30 on the molding tool 20, thus to form a laminate having a target shape.

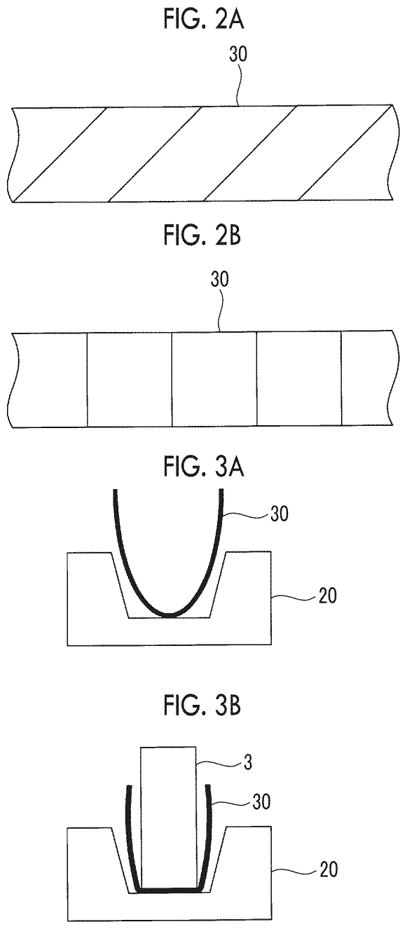

The prepreg 30 has a tape shape long in one direction, and may be wound in a roll shape to be accommodated in the prepreg supply unit 2 before being supplied. The direction of fibers in the prepreg 30 may be parallel to a longitudinal direction of the prepreg 30, or as illustrated in FIGS. 2A and 2B, the fibers may be disposed at a predetermined angle with respect to the longitudinal direction (for example, 45° (FIG. 2A), 90° (FIG. 2B), or the like). The prepreg 30 is produced by, for example, a prepreg production device (not illustrated). The prepreg production device is a device which forms the prepreg 30 having a tape shape long in the one direction, and discharges the fibers in a direction at the predetermined angle with respect to the longitudinal direction, and laminates the fibers in a single layer or a plurality of layers to form the prepreg 30 having a tape shape long in the one direction. Thereafter, the prepreg production device winds the prepreg 30 having a tape shape, which has been formed, in a roll shape. The prepreg 30 wound in a roll shape is supplied from the prepreg supply unit 2.

The prepreg supply unit 2 discharges the prepreg 30 in the one direction to supply the prepreg 30 to the molding tool 20. The prepreg supply unit 2 may be configured to be movable along a longitudinal direction of the molding tool 20. In this case, while the prepreg supply unit 2 moves, the prepreg supply unit 2 supplies the prepreg 30 from one end 20a side to the other end 20b side of the molding tool 20. Incidentally, as will be described later, the prepreg 30 may be progressively placed from the one end 20a side toward the other end 20b side of the molding tool 20, or the prepreg 30 may be discharged in substantially the same length as the length from the one end 20a side to the other end 20b side of the molding tool 20, then to be simultaneously placed inside the molding tool 20 over the entire length.

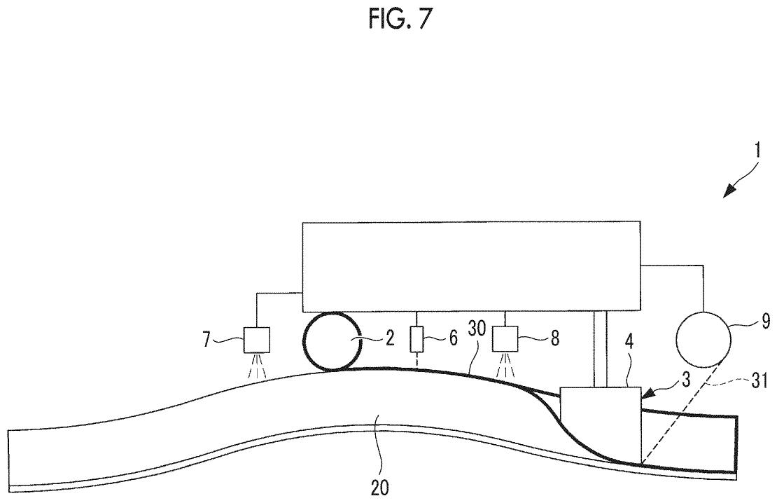

The prepreg supply unit 2 may discharge the prepreg 30 in the one direction to supply the prepreg 30 to the molding tool 20 in a state where a delamination sheet 31 (refer to FIG. 7) is affixed to the prepreg 30. The delamination sheet 31 is affixed to a pressing unit 3 side of the prepreg 30. Accordingly, the prepreg 30 is placed inside the molding tool 20, together with the delamination sheet 31, and the delamination sheet 31 and the prepreg 30 are pressed and deformed by using the pressing unit 3. Therefore, friction generated between the prepreg 30 and the pressing unit 3 is further reduced than when the delamination sheet 31 is not provided. The delamination sheet 31 which has been pressed is recovered by, for example, a delamination sheet recovery unit 9 installed behind the pressing unit 3 in a moving direction.

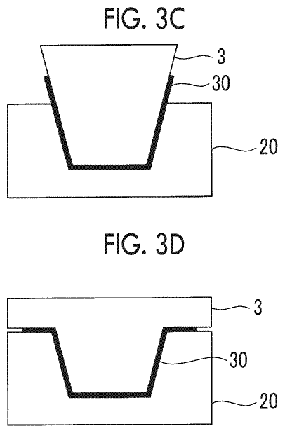

The molding tool 20 has an elongated shape long in the one direction. When the target shape of the laminate to be formed is a hat shape, as illustrated in FIGS. 3A to 3D, the cross-sectional shape of the molding tool 20 is a recessed shape that is depressed in a groove shape. Depending on the shape of the laminate to be formed, the cross-sectional shape of the molding tool 20 may be constant along the longitudinal direction, the cross-sectional shape may change therealong, or a twist or a contour may be formed.

The prepreg 30 before being molded is placed inside a groove-shaped portion of the molding tool 20, and thereafter, is pressed by the pressing unit 3 to be molded into a form according to the shape of the molding tool 20 and the pressing unit 3.

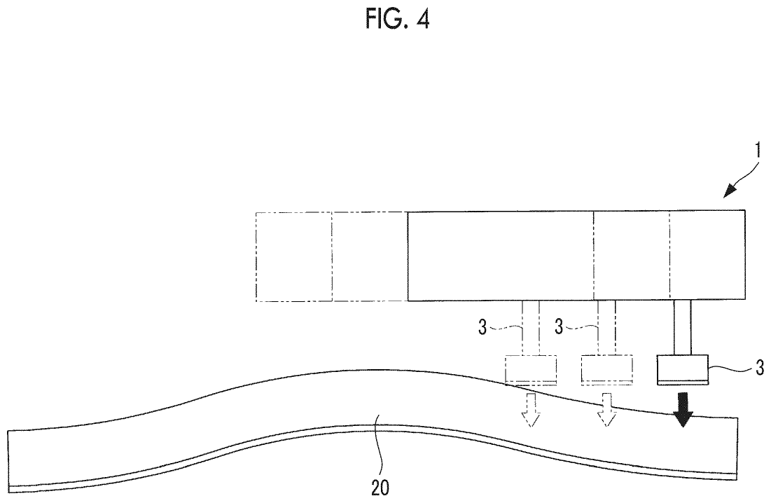

The pressing unit 3 presses the prepreg 30 placed inside the molding tool 20, to deform the prepreg 30 along the molding tool 20. The pressing unit 3 is driven to apply a predetermined pressing force to the molding tool 20 or the prepreg 30. In addition, the pressing unit 3 is movable along the longitudinal direction of the molding tool 20, and while the pressing unit 3 moves, the pressing unit 3 can press the prepreg 30 to deform the prepreg 30 having an elongated shape from one end to the other end. Incidentally, the pressing unit 3 may continuously press the prepreg 30 while sliding along the longitudinal direction, or as illustrated in FIG. 4, may intermittently press the prepreg 30 such as repeating a process of performing pressing at a certain position, releasing the pressing and moving along the longitudinal direction, and then performing pressing at a position after movement.

For example, as illustrated in FIGS. 1 and 3B to 3D, the pressing unit 3 includes a molding portion 4 having a projecting cross section having a shape corresponding to the cross-sectional shape of the molding tool 20. The molding portion 4 may be made of one block-shaped solid. It is desirable that the molding portion 4 is configured to not deform the prepreg 30 from a plate shape to a shape along the molding tool 20 at once, but to gradually deform the prepreg 30 while moving in the longitudinal direction.

The molding portion 4 may be formed of a plurality of movable components, or may be formed of a flexible member such as a membrane. When the molding portion 4 is formed of the plurality of movable components or the flexible member, the cross-sectional shape required for pressing is changeable according to the target shape of the laminate (namely, the cross-sectional shape of the molding tool 20). As a result, it is possible to deform the prepreg 30 to correspond to various shapes without requiring to prepare a plurality of types of the molding portions 4. In addition, instead of deforming the prepreg 30 from a plate shape to the shape along the molding tool 20 at once, it is possible to gradually deform the prepreg 30 while moving the molding tool 20 in the longitudinal direction.

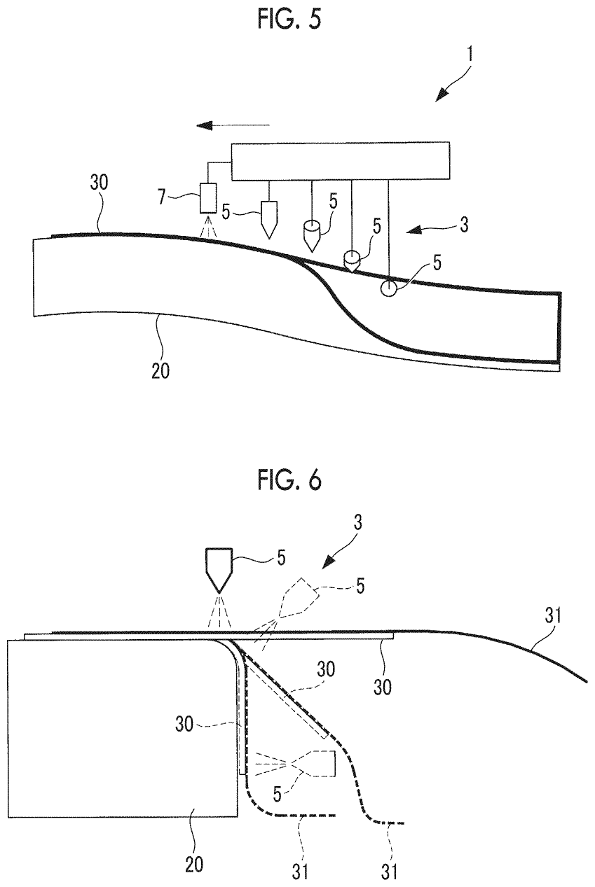

In the case of the above embodiment, the pressing unit 3 causes the molding portion 4 to come into direct contact with the prepreg 30 to press the prepreg 30. The present disclosure is not limited to this example, and as illustrated in FIGS. 5 and 6, the pressing unit 3 may include an injection nozzle 5, and the injection nozzle 5 may inject a fluid (for example, air, an inert gas, or the like). The prepreg 30 is deformed along the molding tool 20 by using the pressure of the fluid injected from the injection nozzle 5.

A plurality of the injection nozzles 5 may be provided on each of both sides in a width direction of the prepreg 30, and may be installed along the longitudinal direction of the molding tool 20. When the plurality of injection nozzles 5 are installed along the longitudinal direction of the molding tool 20, the directions of injection of the injection nozzles 5 may be set to be different from each other. Namely, the direction of injection differs according to a deformation state in which the prepreg 30 is changed from a plate shape to the shape along the molding tool 20. For example, the injection nozzles 5 which inject the fluid to the prepreg 30 immediately after the start of molding inject the fluid downward. The injection nozzles 5 which inject the fluid to the prepreg 30 of which the molding has been almost completed inject the fluid in a horizontal direction.

When the molding portion 4 is used, the molding portion 4 comes into direct contact with the prepreg 30 to press and deform the prepreg 30, so that friction is generated between the molding tool 20 and the prepreg 30. When the prepreg 30 does not slide properly due to frictional force, wrinkles or the like may be generated in the prepreg 30. On the other hand, when the prepreg 30 is deformed along the molding tool 20 by using the pressure of the injected fluid, the prepreg 30 does not come into contact with the molding portion 4, so that wrinkles or the like are less likely to be generated in the prepreg 30.

Incidentally, a molding method using the injection nozzles 5 can be applied to not only when the molding tool 20 includes a portion having a recessed cross section but also when a molding tool (not illustrated) has a projecting cross section. In this case, the prepreg is placed on the molding tool having a projecting cross section, and the prepreg placed on the molding tool is pressed and deformed by the fluid injected from the injection nozzles 5.

As illustrated in FIG. 7, the prepreg lamination molding device 1 may include a slit adding unit 6, heating units 7 and 8, and the delamination sheet recovery unit 9 in addition to the above components.

When the prepreg 30 is placed inside the molding tool 20, the slit adding unit 6 partially cuts the prepreg 30 to form a slit in the prepreg 30. The slit adding unit 6 is, for example, a knife such as a cutter, a laser device that emits laser beams, or the like. The slit to be formed is aligned, for example, in a direction perpendicular to the longitudinal direction of the prepreg 30 (90° direction). Since a slit is formed in the prepreg 30 to increase the plasticity of the prepreg 30, the prepreg 30 is easily deformed by the molding tool 20 and the pressing unit 3.

The heating units 7 and 8 heat the prepreg 30 or the molding tool 20. The heating units 7 and 8 heat an object by, for example, infrared rays, warm air, laser beams, or the like.

The heating unit 7 is installed in front of the prepreg supply unit 2 in the moving direction to heat the molding tool 20 or the prepreg 30 which has already been molded in the molding tool 20. The heating unit 8 is installed behind the prepreg supply unit 2 in the moving direction to heat the prepreg 30 before being placed on the molding tool 20.

Accordingly, before the prepreg 30 is placed on the molding tool 20, or before the prepreg 30 is deformed by using the pressing unit 3, the prepreg 30 or the molding tool 20 is heated. Accordingly, the plasticity of the prepreg 30 is increased, so that the prepreg 30 is easily deformed by the molding tool 20 and the pressing unit 3. In addition, since the adhesiveness of the prepreg 30 is improved due to a rise in temperature, the bonding between the prepregs 30 is enhanced.

The heating unit (not illustrated) may heat the pressing unit 3 from the outside. Alternatively, a heating unit (not illustrated) may be provided inside the pressing unit 3 to cause the pressing unit 3 to generate heat. Accordingly, when the prepreg 30 is deformed by using the pressing unit 3, the pressing unit 3 is heated or the pressing unit 3 generates heat, so that the plasticity of the prepreg 30 is increased. Therefore, the prepreg 30 is easily deformed by the molding tool 20 and the pressing unit 3. In addition, since the adhesiveness of the prepreg 30 is improved due to a rise in temperature, the bonding between the prepregs 30 is enhanced.

Next, a method for lamination molding the prepreg 30 according to the present embodiment will be described.

First, the prepreg supply unit 2 discharges the prepreg 30, and supplies the prepreg 30 to the molding tool 20. The prepreg supply unit 2 supplies the prepreg 30 while moving from the one end 20a side to the other end 20b side along the longitudinal direction of the molding tool 20.

The prepreg 30 supplied from the prepreg supply unit 2 is bent into a U shape of which a central portion in the width direction is located on a lower side and of which the cross-sectional shape projects downward. Then, as illustrated in FIG. 3A, the prepreg 30 is placed inside the molding tool 20 such that a lower portion of the prepreg 30 bent into a U shape comes into contact with a bottom portion of the molding tool 20 having a recessed cross section.

Then, the pressing unit 3 presses the prepreg 30 while moving from the one end 20a side to the other end 20b side along the longitudinal direction of the molding tool 20. As illustrated in FIGS. 3B to 3D, the pressing unit 3 presses and deforms the prepreg 30 placed inside the molding tool 20.

When the prepreg 30 is deformed from the one end 20a side to the other end 20b side on the molding tool 20 by the pressing unit 3, the molding of the prepreg 30 of a first layer is completed.

Next, the prepreg supply unit 2 again supplies the prepreg 30 to the molding tool 20 while moving from the one end 20a side to the other end 20b side along the longitudinal direction of the molding tool 20. Similar to the prepreg 30 molded previously, the prepreg 30 supplied from the prepreg supply unit 2 is bent into a U shape of which the cross-sectional shape projects downward. Then, the prepreg 30 is placed inside the molding tool 20 such that a lower portion of the prepreg 30 bent into a U shape comes into contact with the prepreg 30 molded and placed along the molding tool 20.

Then, the pressing unit 3 presses the prepreg 30 while moving from the one end 20a side to the other end 20b side along the longitudinal direction of the molding tool 20. The pressing unit 3 presses and deforms the prepreg 30 placed inside the molding tool 20. When the prepreg 30 is deformed from the one end 20a side to the other end 20b side on the prepreg 30 of the first layer by the pressing unit 3, the molding of the prepreg 30 of a second layer is completed.

When the above-described operation is repeated to lamination mold a required number of layers of the prepregs 30, a molded body is formed, and the lamination molding of the prepregs 30 is completed.

Since the prepregs 30 are molded one by one, when the prepregs 30 are deformed by the pressing unit 3, the plurality of prepregs 30 are not required to slide simultaneously. For this reason, the generation of wrinkles due to the prepreg 30 not sliding properly between the plurality of prepregs 30 is suppressed. Particularly, the generation of wrinkles by the influence of an arc-shaped (rounded) portion having a large curvature in a recessed portion or a portion which is three-dimensionally shaped (contoured) in a longitudinal direction is suppressed.

The cross-sectional shape of the prepreg 30 is deformed into a U shape, and as illustrated in FIG. 3A, the prepreg 30 is placed inside the molding tool 20 such that a lower portion of the prepreg 30 comes into contact with the bottom portion of the molding tool 20. Then, the pressing unit 3 presses and deforms the prepreg 30 placed inside the molding tool 20. Accordingly, when molding is performed by using the pressing unit 3, the prepreg 30 to be newly molded is deformed without generating slippage with respect to the molding tool 20, so that the generation of wrinkles is suppressed.

When the prepreg 30 deformed along the molding tool 20 is placed inside the molding tool 20, the cross-sectional shape of the prepreg 30 is deformed into a U shape, and as illustrated in FIG. 3A, the prepreg 30 is placed inside the molding tool 20 such that a lower portion of the prepreg 30 comes into contact with an upper surface of the prepreg 30 molded on the molding tool 20. Then, the pressing unit 3 presses and deforms the prepreg 30 placed inside the molding tool 20. Accordingly, when molding is performed by using the pressing unit 3, the prepreg 30 to be newly molded is deformed without generating slippage with respect to the prepreg 30 which has already been molded, so that the generation of wrinkles is suppressed.

Next, a method for supplying the prepreg 30 will be further described.

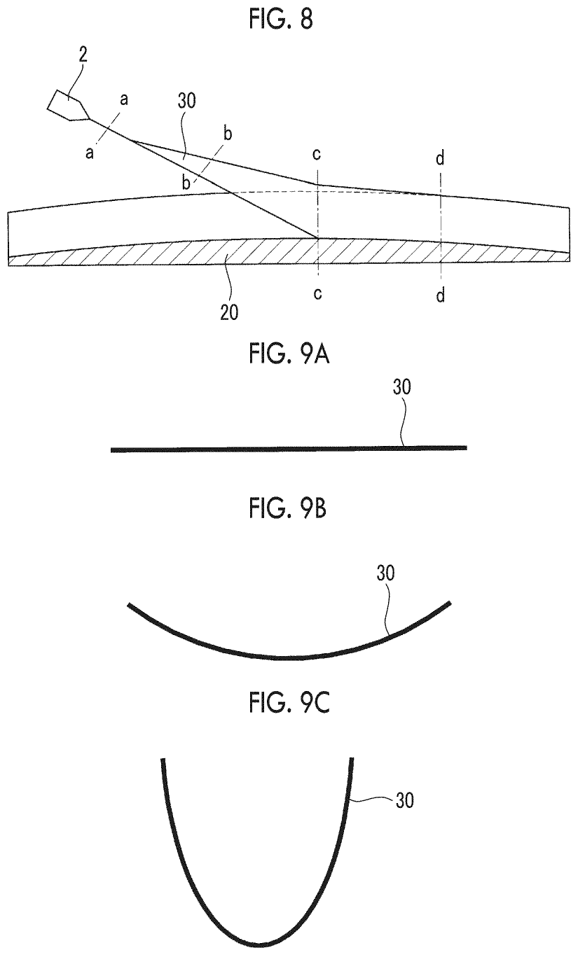

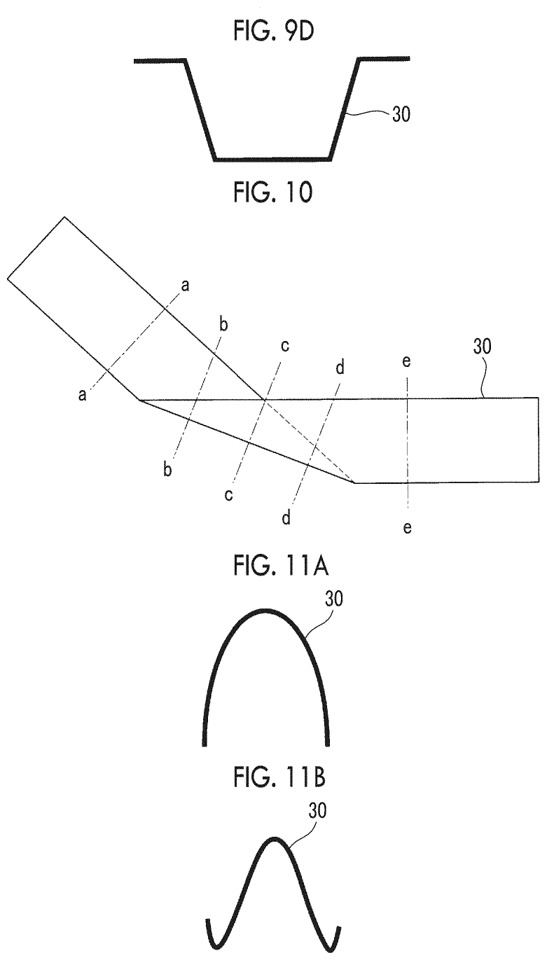

First, as illustrated in FIGS. 8, 9A and 9B, before the prepreg 30 is placed on the molding tool 20, the prepreg 30 is progressively deformed from one end side toward the other end side in the longitudinal direction such that the cross-sectional shape of the prepreg 30 becomes a U shape.

Then, as illustrated in FIG. 9C, the prepreg 30 deformed into a U shape is progressively placed inside the molding tool 20 from the one end 20a side toward the other end 20b side of the molding tool 20. In this case, the prepreg 30 is supplied obliquely downward toward the molding tool 20, and the direction of the prepreg 30 is changed at a placement start position at which the prepreg 30 is to be placed inside the molding tool 20.

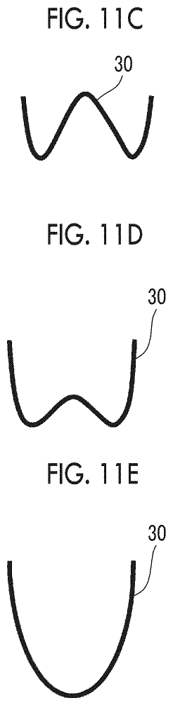

As illustrated in FIGS. 10 and 11A to 11E, the cross-sectional shape of the prepreg 30 is changed from an upward projecting U shape to a downward projecting U shape at the placement start position. Namely, when the prepreg 30 is discharged from the prepreg supply unit 2, the cross section has an upward projecting U shape, a central portion in the width direction is located on an upper side, and both end portions are located on a lower side. Then, in order to change the direction, both end portions of the prepreg 30 having a cross section of an upward projecting U shape are raised toward the upper side, and the height of the central portion in the width direction is lowered. As the prepreg 30 approaches the molding tool 20, the height of the central portion in the width direction is lowered while the height of both end portions of the prepreg 30 is raised, so that the cross-sectional shape is changed to a downward projecting U shape.

Since the cross-sectional shape of the prepreg 30 is changed from an upward projecting U shape to a downward projecting U shape at the placement start position, the prepreg 30 does not extend further outward than the width of the molding tool 20 in a bent portion, and the cross-sectional shape of the prepreg 30 is stably changed to a downward projecting U shape at the placement start position to be smoothly accommodated in the molding tool 20.

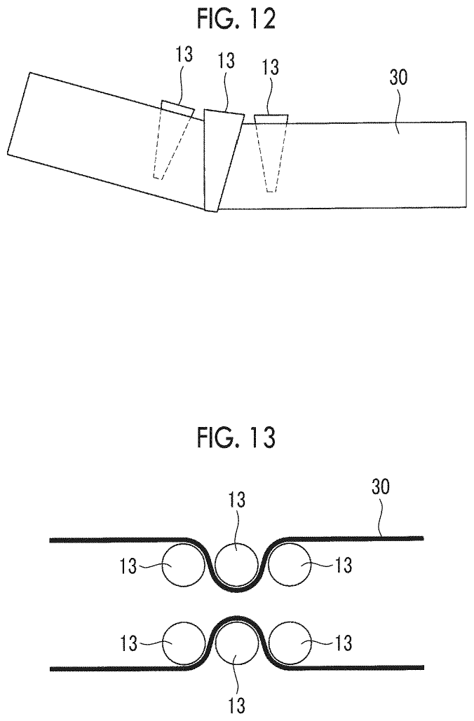

The prepreg 30 may be placed on the molding tool 20 by another method instead of the above method. As illustrated in FIGS. 12 and 13, upper portions on both sides of a downward projecting U shape are bent inward and disposed at the placement start position. Namely, three rollers 13 each having a conical shape are installed at each of both ends of the prepreg 30 along the longitudinal direction at the placement start position. A large diameter portion of the roller 13 having a conical shape is located on the upper side, namely, an end portion side of the prepreg 30, and a small diameter portion thereof is located on the lower side, namely, a center side in the width direction of the prepreg 30. The prepreg 30 is sent from an outer side of the rollers 13 of a first stage to an inner side of the rollers 13 at the center (second stage), and thereafter, is sent from the inner side of the rollers 13 at the center to an outer side of the rollers 13 of a third stage. The large diameter portion of the roller 13 having a conical shape is located closer to the center than the end portion of the prepreg 30. Accordingly, the prepreg 30 does not extend further outward than the width of the molding tool 20 in a bent portion, and the prepreg 30 is stably accommodated in the molding tool 20 at the placement start position.

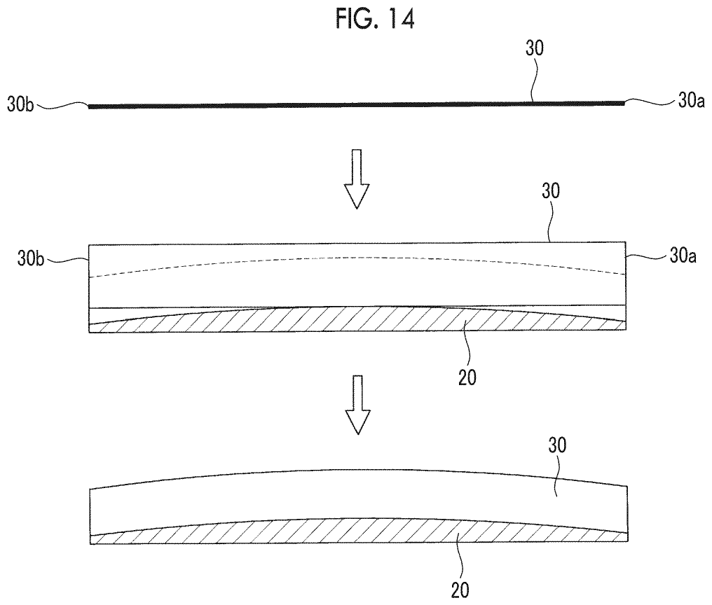

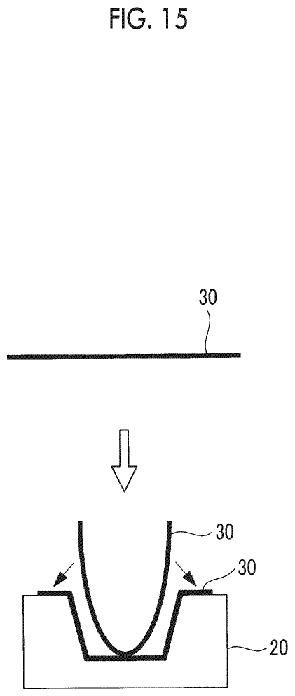

In the method for supplying the prepreg 30 described above, a case where the prepreg 30 is progressively deformed from the one end side toward the other end side to be progressively placed on the molding tool 20 has been described; however, as illustrated in FIGS. 14 and 15, after the prepreg 30 having a required length is prepared, the prepreg 30 may be simultaneously placed on the molding tool 20 over the entire length.

In this case, before the prepreg 30 is placed on the molding tool 20, the prepreg 30 is simultaneously deformed from one end 30a side to the other end 30b side in the longitudinal direction such that the cross-sectional shape of the prepreg 30 becomes a U shape. Then, the prepreg 30 deformed into a U shape is simultaneously placed inside the molding tool 20 from the one end 20a side to the other end 20b side of the molding tool 20. Accordingly, upper portions on both sides of a downward projecting U shape are bent inward over the entire length at a placement position, and the cross-sectional shape of the prepreg 30 is stably changed to a downward projecting U shape at the placement position.

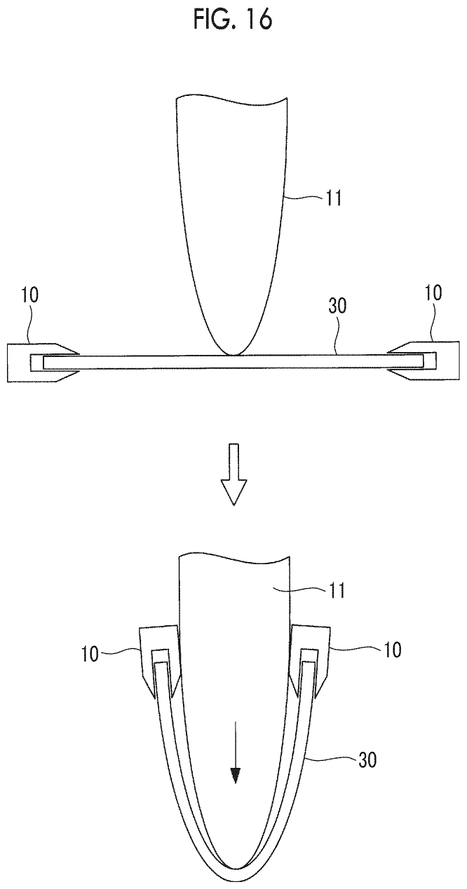

A method for deforming the prepreg 30 into a downward projecting U shape over the entire length is, for example, as follows. As illustrated in FIG. 16, clamp portions 10 and a push portion 11 are provided. Then, the clamp portions 10 clamp the end portions in the width direction of the prepreg 30 having a plate shape, and the push portion 11 pushes the center of the prepreg 30 downward. Accordingly, the prepreg 30 is deformed from a plate shape to a downward projecting U shape. In this case, as the prepreg 30 is deformed, the direction of the clamp portions 10 is changed from a lateral direction to a downward direction.

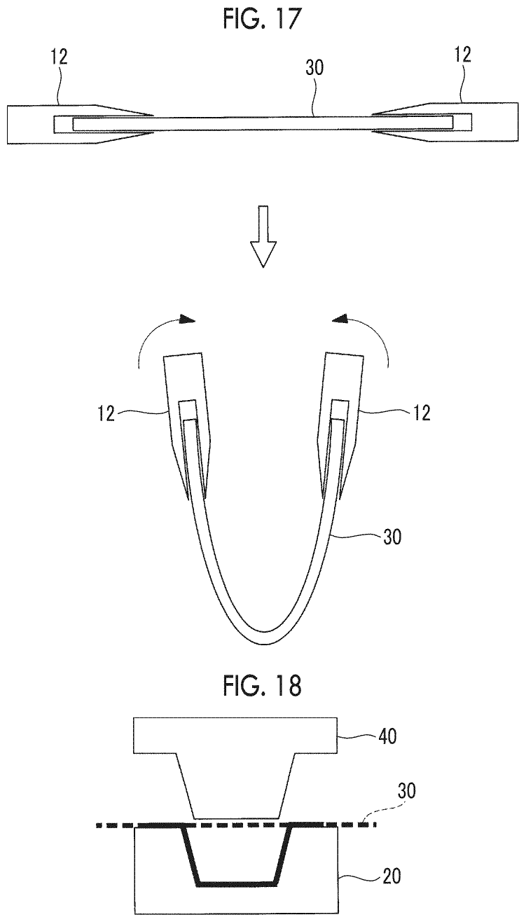

Alternatively, as illustrated in FIG. 17, bending portions 12 are provided. Then, the bending portions 12 clamp the end portions in the width direction of the prepreg 30 having a plate shape, and the bending portions 12 are driven. The bending portions 12 move to the center side of the prepreg 30 while rotating. As a result, the direction of the bending portions 12 is changed from the lateral direction to the downward direction, and the prepreg 30 is deformed from a plate shape to a downward projecting U shape.

Next, a method for molding the prepreg 30 will be described.

As illustrated in FIG. 7, when the heating unit 7 is installed, before the prepreg 30 is disposed inside the molding tool 20, the molding tool 20 or the prepreg 30 which has already been molded inside the molding tool 20 may be heated. Accordingly, the temperature of a region in which the prepreg 30 is newly disposed can be raised. When the slit adding unit 6 or the heating unit 8 is installed, before the prepreg 30 is disposed inside the molding tool 20, a slit may be formed in the prepreg 30 or the prepreg 30 may be heated. Accordingly, the prepreg 30 to be newly molded is easily deformed, and the bonding between the prepregs 30 is improved.

Thereafter, the pressing unit 3 presses the prepreg 30 disposed inside the molding tool 20. At this time, the pressing unit 3 may be heated or the pressing unit 3 may generate heat. Accordingly, the prepreg 30 to be newly molded is easily deformed, and the bonding between the prepregs 30 is improved.

The pressing unit 3 moves from the one end 20a side to the other end 20b side of the molding tool 20. In this case, when the pressing unit 3 includes the molding portion 4, the molding portion 4 may continuously press the prepreg 30 while sliding along the longitudinal direction, or as illustrated in FIG. 4, may intermittently press the prepreg 30 while moving in the longitudinal direction.

As illustrated in FIGS. 5 and 6, when the pressing unit 3 includes the injection nozzles 5, the injection nozzles 5 inject the fluid to the prepreg 30 while moving in the longitudinal direction. When the plurality of injection nozzles 5 are installed along the longitudinal direction and are provided to having different directions of injection, the shape of the prepreg 30 is gradually changed from a plate shape to the shape along the molding tool 20.

As described above, according to the present embodiment, the cross-sectional shape of the prepreg 30 is deformed into a U shape, and as illustrated in FIG. 3A, the prepreg 30 is placed inside the molding tool 20 such that the lower portion of the prepreg 30 comes into contact with the bottom portion of the molding tool 20 or the upper surface of the prepreg 30 deformed along the molding tool 20. Then, the pressing unit 3 presses and deforms the prepreg 30 placed inside the molding tool 20.

In the related art, as illustrated in FIG. 18, the prepreg 30 is placed on an upper surface of the molding tool 20 while maintaining a plate shape. Then, the prepreg 30 is pushed into the molding tool 20 while being pressed by a pressing unit 40. In this case, the prepreg 30 is pressed and deformed while generating friction with the molding tool 20 or the prepreg 30 placed along the molding tool 20. For this reason, when the prepreg 30 does not slide properly between the prepregs 30 (between layers) due to frictional force, wrinkles or the like may be generated.

Meanwhile, according to the present embodiment, as illustrated in FIG. 3A, the lower portion of the prepreg 30 comes into contact with the bottom portion of the molding tool 20 or the upper surface of the prepreg 30 deformed along the molding tool 20. For this reason, when molding is performed by using the pressing unit 3, the prepreg 30 to be newly molded is deformed without generating slippage with respect to the molding tool 20, so that the generation of wrinkles is suppressed.

### REFERENCE SIGNS LIST

1: Prepreg lamination molding device
2: Prepreg supply unit
3: Pressing unit
4: Molding portion
5: Injection nozzle
6: Slit adding unit
7: Heating unit
8: Heating unit
9: Delamination sheet recovery unit
10: Clamp portion
11: Push portion
12: Bending portion
13: Roller
20: Molding tool
30: Prepreg
40: Pressing unit

1. A prepreg molding method comprising:
a step of bending a first prepreg to have a downward projecting U shape in a cross-sectional shape, the first prepreg having an elongated shape long in one direction;
a step of placing the first prepreg inside a molding tool having a recessed cross section such that a lower portion of the first prepreg bent into a U shape comes into contact with a bottom portion of the molding tool or an upper surface of a second prepreg molded and placed along the molding tool; and
a step of pressing and deforming the first prepreg, which is placed inside the molding tool, by using a pressing unit.

2. The prepreg molding method according to claim 1,
wherein the first prepreg is supplied toward the molding tool to be placed on the molding tool such that a direction of fibers has a predetermined angle with respect to a longitudinal direction.

3. The prepreg molding method according to claim 1,
wherein the first prepreg is progressively deformed from one end side toward the other end side in a longitudinal direction such that the cross-sectional shape of the first prepreg becomes a U shape, and
the first prepreg deformed into a U shape is progressively placed inside the molding tool from one end side toward the other end side of the molding tool.

4. The prepreg molding method according to claim 3,
wherein the first prepreg is supplied toward the molding tool, and a direction of the first prepreg is changed at a placement position at which the first prepreg is to be placed inside the molding tool, and
at the placement position, the cross-sectional shape of the first prepreg is changed from an upward projecting U shape to a downward projecting U shape, or upper portions on both sides of a downward projecting U shape are bent inward and disposed.

5. The prepreg molding method according to claim 1,
wherein the first prepreg is simultaneously deformed from one end side to the other end side in a longitudinal direction such that the cross-sectional shape of the first prepreg becomes a U shape, and
the first prepreg deformed into a U shape is simultaneously placed inside the molding tool from one end side to the other end side of the molding tool.

6. The prepreg molding method according to claim 1,
wherein the first prepreg is placed inside the molding tool, together with a delamination sheet, and the delamination sheet and the first prepreg are pressed and deformed by using the pressing unit.

7. The prepreg molding method according to claim 1,
wherein when the first prepreg is placed inside the molding tool, a slit is formed in the first prepreg.

8. The prepreg molding method according to claim 1,
wherein before the first prepreg is placed on the molding tool, the molding tool or the second prepreg is heated.

9. The prepreg molding method according to claim 1,
wherein before the first prepreg is deformed by using the pressing unit, the first prepreg is heated.

10. The prepreg molding method according to claim 1,
wherein the pressing unit is heated or caused to generate heat, and the first prepreg is deformed by using the pressing unit.

11. The prepreg molding method according to claim 1,
wherein the pressing unit has a projecting cross section having a shape corresponding to a cross-sectional shape of the molding tool.

12. The prepreg molding method according to claim 1,
wherein the pressing unit is configured such that a cross-sectional shape of the pressing unit is changeable according to a target shape of a laminate.

13. The prepreg molding method according to claim 1,
wherein the pressing unit is an injection nozzle that injects a fluid, and deforms the first prepreg along the molding tool by using a pressure of the injected fluid.

14. A prepreg molding method comprising:
a step of placing a first prepreg on a molding tool having a recessed cross section or a projecting cross section; and
a step of pressing and deforming the first prepreg, which is placed on the molding tool, by using a pressing unit,
wherein the pressing unit is an injection nozzle that injects a fluid, and deforms the first prepreg along the molding tool by using a pressure of the injected fluid.
